(19) United States
(12) Patent Application Publication
(10) Pub. No.: US 2022/0227375 A1
(43) Pub. Date: Jul. 21, 2022

(54) INFORMATION PROCESSING DEVICE, INFORMATION PROCESSING METHOD, COMPUTER READABLE MEDIUM, AND MAP STORAGE DEVICE

(71) Applicant: DENSO TEN Limited, Kobe-shi (JP)

(72) Inventors: Motoki KOJIMA, Kobe-shi (JP); Hiroyuki WATABE, Kobe-shi (JP); Shinichi SHIOTSU, Kobe-shi (JP); Tomoe OHTSUKI, Kobe-shi (JP); Kazuma HASHIMOTO, Kobe-shi (JP); Haruo HARADA, Kobe-shi (JP)

(73) Assignee: DENSO TEN Limited, Kobe-shi (JP)

(21) Appl. No.: 17/210,986

(22) Filed: Mar. 24, 2021

(30) Foreign Application Priority Data
Jan. 19, 2021 (JP) 2021-006665
Jan. 19, 2021 (JP) 2021-006666

(51) Int. Cl. B60W 40/09; B60W 40/10; B60W 60/00; G02B 27/01

(52) U.S. Cl. CPC B60W 40/09; B60W 40/10; B60W 2040/0872; G02B 27/0172; B60W 60/00136

(57) ABSTRACT

An information processing device that is mountable on a vehicle, includes: an acquiring unit configured to acquire at least one of internal condition or external condition of a user of a digital content including a virtual space experience; an estimating unit configured to estimate a sickness status of the user based on the at least one of internal condition or external condition acquired by the acquiring unit; and a guidance processing unit configured to perform a guidance processing such that a driving state of the vehicle is guided to suppress sickness, depending on the sickness status of the user estimated by the estimating unit.

### CROSS-REFERENCE TO RELATED APPLICATIONS

This application is based on and claims priorities under 35 USC 119 from Japanese Patent Application No. 2021-006665 filed on Jan. 19, 2021 and Japanese Patent Application No. 2021-006666 filed on Jan. 19, 2021, the contents of which are incorporated herein by reference.

### TECHNICAL FIELD

Embodiments to be disclosed relates to an information processing device and a map storage device.

### BACKGROUND ART

Technology for providing digital contents including virtual space experiences such as virtual reality (VR) and mixed reality (MR) to users using head mounted displays (HMDs) and the like has been known.

Also, VR systems which can be mounted on movable bodies such as vehicles and use the movable bodies as motion platforms have been proposed (see JP-A-2017-102401 for instance).

### SUMMARY OF INVENTION

However, the technology according to the related art have room for improvement in preventing user's sickness from being caused by digital contents including virtual space experiences.

For example, it is known that VR contents may cause “VR sickness” similar to carsickness in users who experience them. VR sickness is one of motion sickness which may be caused by a disagreement between a video and the motion of the user's body. In particular, in the case of a VR system mounted on a vehicle, the motion of the vehicle is added to the motion of the user's body, and thus a disagreement with a video tends to be complicated and VR sickness tends to be likely to occur. Further, since general carsickness symptoms are also added, more complicated sickness symptoms are likely to occur.

An aspect of embodiments was made in view of the circumstances, and an object thereof is to provide an information processing device and a map storage device capable of preventing user's sickness from being caused by digital contents including virtual space experiences.

According to an aspect of the embodiments, it is provided an information processing device that is mountable on a vehicle, including: an acquiring unit configured to acquire at least one of internal condition or external condition of a user of a digital content including a virtual space experience; an estimating unit configured to estimate a sickness status of the user based on the at least one of internal condition or external condition acquired by the acquiring unit; and a guidance processing unit configured to perform a guidance processing such that a driving state of the vehicle is guided to suppress sickness, depending on the sickness status of the user estimated by the estimating unit.

According to the aspect of the embodiments, it is possible to prevent user's sickness from being caused by digital contents including virtual space experiences.

### BRIEF DESCRIPTION OF DRAWINGS

FIG. 1 is a view illustrating a rough configuration of an information processing system according to a first embodiment.

FIG. 2 is a view for explaining VR sickness.

FIG. 3 is a view for explaining the outline of an information processing method according to the first embodiment.

FIG. 4 is a block diagram illustrating a configuration example of the information processing system according to the first embodiment.

FIG. 5 is a block diagram illustrating a configuration example of a guidance processing unit.

FIG. 6 is a view illustrating examples of thresholds at which guidance processing is triggered.

FIG. 7 is a view illustrating instruction contents in operation instruction processing.

FIG. 8 is a view illustrating an output example of the operation instruction processing.

FIG. 9 is a view illustrating examples of parameters which can be changed by driving-performance changing processing.

FIG. 10 is a view for explaining driving-route changing processing.

FIG. 11 is another view for explaining the driving-route changing processing.

FIG. 12 is a flow chart illustrating procedures of processing by the information processing device according to the embodiment performs.

FIG. 13 is a flow chart illustrating the procedures of the operation instruction processing.

FIG. 14 is a flow chart illustrating the procedures of the driving-performance changing processing.

FIG. 15 is a flow chart illustrating the procedures of the driving-route changing processing.

FIG. 16 is a view for explaining the outline of an information processing method according to a second embodiment.

FIG. 17 is a block diagram illustrating a configuration example of an information processing system according to the second embodiment.

FIG. 18 is another block diagram illustrating the configuration example of the information processing system according to the second embodiment.

FIG. 19 is a view illustrating an example of notification of information on VR sickness.

FIG. 20 is a view illustrating an example of notification of ranking information.

FIG. 21 is a view illustrating an example of ranking.

FIG. 22 is a flow chart illustrating procedures of processing by an information processing device according to the second embodiment.

### DESCRIPTION OF EMBODIMENTS

Hereinafter, embodiments of an information processing device and a map storage device to be disclosed in this application will be described in detail with reference to the accompanying drawings. However, this invention is not limited to the following embodiments.

Further, hereinafter, an information processing system 1 according to the embodiments will be described taking as an example the case where an information processing system 1 or 101 according to the embodiments is an in-vehicle system that is mountable on a vehicle. Also, the following description will be made on the assumption that an information processing system 1 or 101 according to the embodiments is a VR system for providing VR contents as digital contents including a virtual space experiences to users.

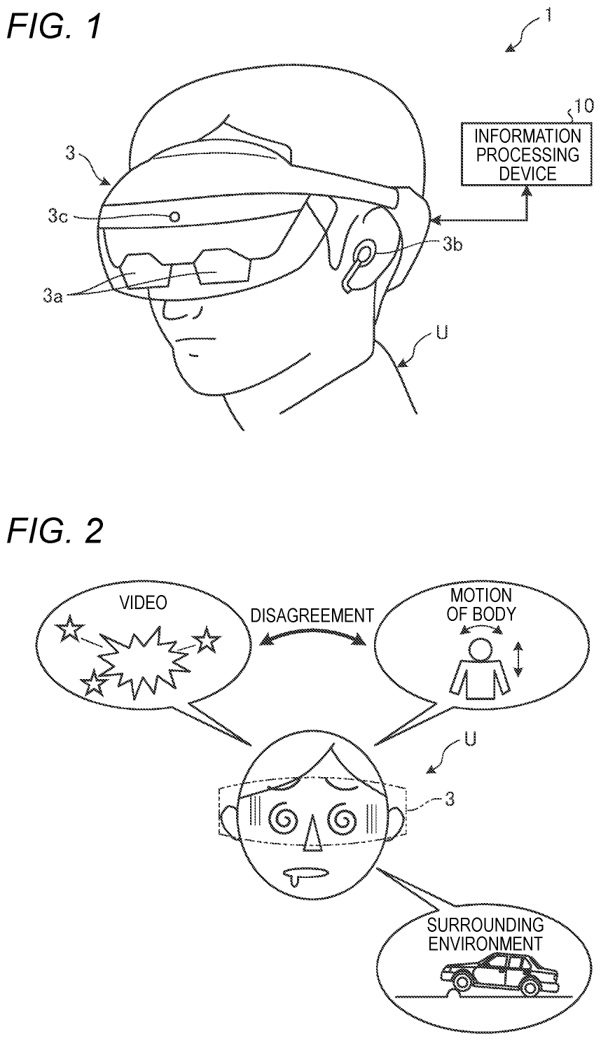

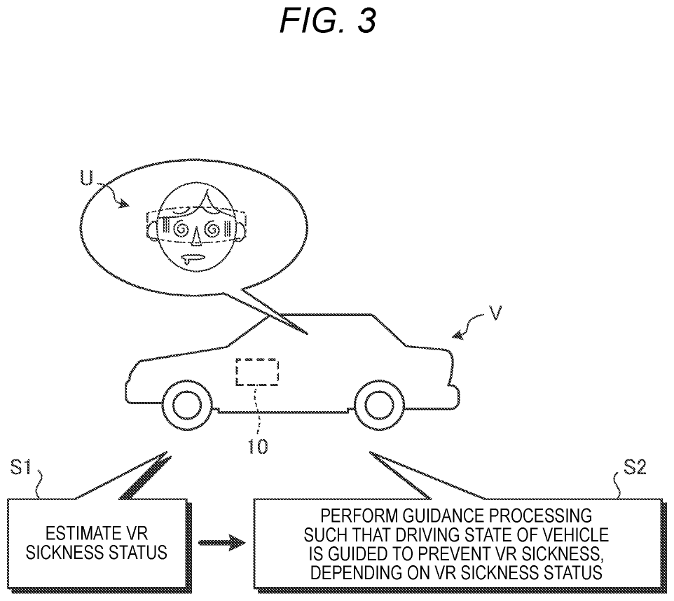

First, the outline of an information processing method according to a first embodiment will be described with reference to FIG. 1 to FIG. 3. FIG. 1 is a view illustrating a rough configuration of an information processing system 1 according to the first embodiment. FIG. 2 is a view for explaining VR sickness. FIG. 3 is a view for explaining the outline of the information processing method according to the first embodiment.

As shown in FIG. 1, the information processing system 1 according to the first embodiment includes an HMD 3 and an information processing device 10.

The HMD 3 is an information processing terminal for presenting VR contents provided by the information processing device 10 such that a user can enjoy virtual space experiences. The HMD 3 is a wearable computer which can be worn on the head of a user U to be used. In the example of FIG. 1, the HMD 3 is a goggle type. However, the HMD 3 may be an eyeglass type, or may be a hat type.

The HMD 3 includes display units 3a, a speaker 3b, and a sensor unit 3c. The display units 3a are provided such that they can be placed in front of the eyes of the user U, and display a video included in a VR content provided by the information processing device 10.

In the example of FIG. 1, an example in which two display units 3a are provided in front of the left and right eyes of the user U, respectively; however, only one display unit may be provided. Also, the display units 3a may be a non see-through type for completely covering the field of view, or may be a video see-through type or an optical see-through type. In the present embodiment, it is assumed that they are the non see-through type.

The speaker 3b is, for example, a headphone type as shown in FIG. 1 and is configured to be placed on the ears of the user U. The speaker 3b outputs sound included in VR contents which are provided by the information processing device 10.

The sensor unit 3c is a device for detecting changes in the internal and external conditions of the user U, and includes, for example, cameras, motion sensors, etc.

The information processing device 10 is, for example, a computer, and is an in-vehicle device which is mounted on a vehicle, and is connected to the HMD 3 by wire or radio, and provides VR contents to the HMD 3. Also, the information processing device 10 acquires changes in the conditions detected by the sensor unit 3c as needed, and reflects the changes in the conditions to the VR contents.

For example, the information processing device 10 can change the direction of the view field in the virtual space of a VR content, according to the head and sight line of the user U detected by the sensor unit 3c.

By the way, it is known that when providing a VR content using such an HMD 3, it may cause “VR sickness” similar to carsickness in the user U.

As shown in FIG. 2, VR sickness may be caused by some causes such as a disagreement between a video and the motion of the body of the user U. Also, in the case of a VR system which is mounted on a vehicle, the motion of the vehicle attributable to changes in the surrounding environment and so on is further added to the motion of the user, so a disagreement with a video tends to be more complicated, and VR sickness tends to be likely to occur.

For this reason, the information processing method according to the first embodiment is an information processing method using the information processing device 10 that is mountable on a vehicle, and is configured to acquire the internal and external conditions of the user U, and estimate the VR sickness status of the user U on the basis of the acquired conditions, and perform a guidance processing such that the driving state of the vehicle is guided to suppress VR sickness, depending on the estimated VR sickness status.

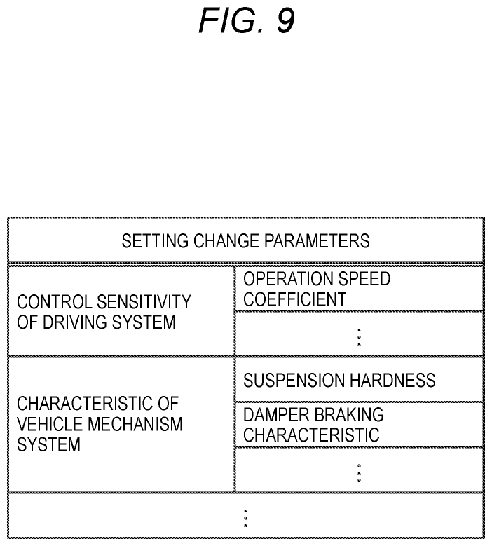

Specifically, as shown in FIG. 9, in the information processing method according to the first embodiment, the information processing device 10 acquires the internal and external conditions of the user U as needed, and estimates the VR sickness status of the user U (STEP S1). The information processing device 10 estimates the VR sickness status, for example, by detecting changes in the physical condition of the user U.

Also, the information processing device 10 estimates the VR sickness status on the basis of VR content use states such as the type of the VR content which is being provided, the video state, and the sound state.

Also, the information processing device 10 estimates the VR sickness status on the basis of the driving states of a vehicle V such as the road condition, the condition of the vehicle V, and the operation condition. Also, the information processing device 10 estimates the VR sickness status on the basis of user information including various parameters representing, for example, the sickness likelihoods and so on of individual users.

By the way, the information processing device 10 can use an estimation model generated using, for example, a machine learning algorithm, in the VR sickness status estimating process. The estimation model is appropriately learned on the basis of actual VR sickness status estimation results by reinforcement learning. As the result of the reinforcement learning, for example, determination thresholds and so on for estimating the VR sickness status are appropriately updated.

Subsequently, the information processing device 10 performs a guidance processing such that the driving state of the vehicle V is guided to suppress VR sickness, according to the estimation result of STEP S1 (STEP S2).

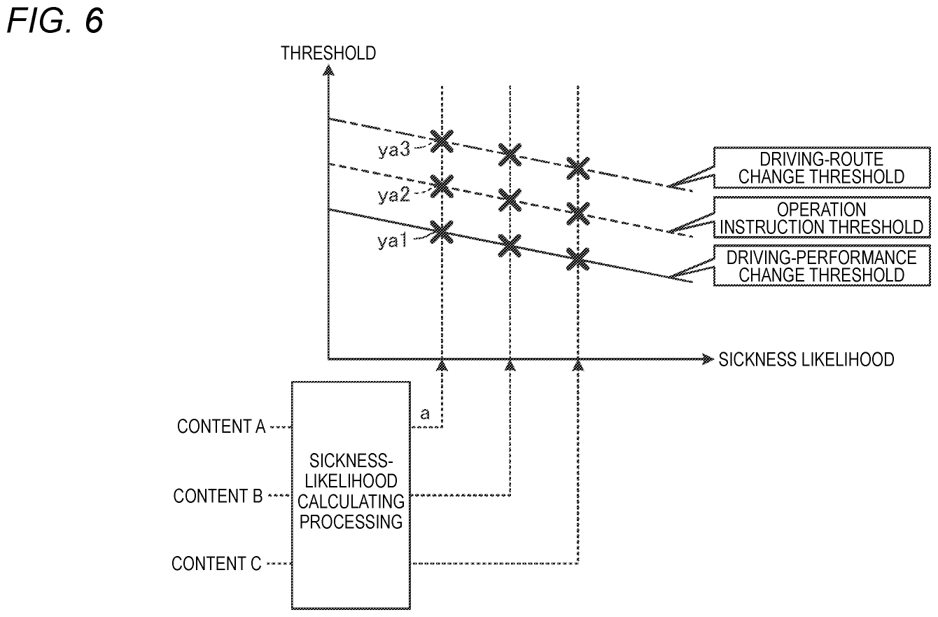

An example of the guidance processing is an “operation instruction processing” to instruct the driver of the vehicle V in the driving operation method. Another example of the guidance processing is a “driving-performance changing processing” to change the setting related to the driving performance of the vehicle V. A further example of the guidance processing is a “driving-route changing processing” to change the driving route of the vehicle V. Details of the guidance processing will be described below with reference to FIG. 6 to FIG. 11.

By performing the guidance processing, it may be possible to prevent VR sickness of the user U from being caused by the VR content.

As described above, the information processing method according to the first embodiment is an information processing method using the information processing device 10 that is mountable on the vehicle V, and is configured to acquire the internal and external conditions of the user U, and estimate a VR sickness status of the user U on the basis of the acquired conditions, and perform a guidance processing such that the driving state of the vehicle V is guided to suppress VR sickness, depending on the estimated VR sickness status.

Therefore, according to the information processing method of the first embodiment, it is possible to prevent VR sickness of the user U from being caused by the VR content. Hereinafter, configuration examples of an information processing system 1 using the information processing method according to the embodiment will be described in more detail.

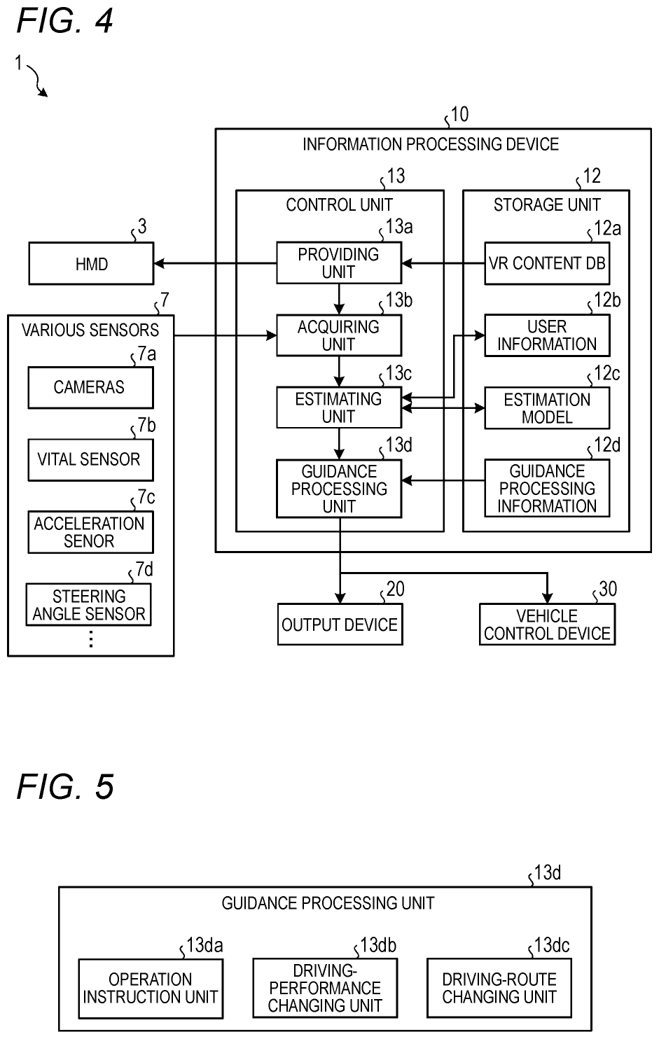

FIG. 4 is a block diagram illustrating a configuration example of an information processing system 1 according to the first embodiment. FIG. 5 is a block diagram illustrating a configuration example of a guidance processing unit 13d. In FIG. 4 and FIG. 5, only components necessary to explain the features of the first embodiment are shown, and general components are not shown.

In other words, the individual components shown in FIG. 4 and FIG. 5 are functionally conceptual, and do not necessarily need to be configured physically as shown in the drawings. For example, specific forms of distribution and combination of the individual blocks are not limited to that shown in the drawings, and all or some of them may be functionally and physically distributed or combined in desired units, depending on various types of loads, use states, etc.

Further, in descriptions using FIG. 4 and FIG. 5, a description of the components having been already described will be made in brief or will not be made.

As shown in FIG. 4, the information processing system 1 according to the first embodiment includes the HMD 3 and the information processing device 10.

The HMD 3 has been already described with reference to FIG. 1, so a description thereof will not be made here. The information processing device 10 includes a storage unit 12 and a control unit 13. Also, the information processing device 10 is connected to various sensors 7, an output device 20, and a vehicle control device 30 directly or through a network such as a controller area network (CAN).

The various sensors 7 are a group of sensors for sensing the internal and external conditions of the vehicle V, and include, for example, cameras 7a, a vital sensor 7b, an acceleration senor 7c, a steering angle sensor 7d, etc.

The cameras 7a are a front camera, a rear camera, side cameras, an in-vehicle camera, and the like which are mounted on the vehicle V, and images the inside and outside of the vehicle V. The in-vehicle camera images, for example, the state of the user U.

The vital sensor 7b is a sensor for sensing the physical condition of the user U, and may be attached to the user U, and measures vital data such as the heart rate, the brain wave, the blood oxygen level, sweating, etc. of the user U.

The acceleration sensor 7c measures the acceleration and speed applied to the vehicle V. The steering angle sensor 7d measures the steering angle of the vehicle V. The various sensors 7 may include sensors other than the individual sensors 7a to 7d shown in FIG. 4.

The output device 20 is a device for outputting information toward the inside of the vehicle, and includes a display 21, a speaker 22, and so on to be described below. The output device 20 is implemented with, for example, a car navigation device. The vehicle control device 30 is a device for controlling the vehicle V, and is an electronic control unit (ECU) or the like for controlling running system devices such as the engine, the transmission, the brake, the suspension, etc.

The storage unit 12 is implemented with, for example, semiconductor memory devices such as a random access memory (RAM) and a flash memory, or storage devices such as a hard disk and an optical disk, and in the example of FIG. 4, the storage unit stores a VR content database (DB) 12a, user information 12b, an estimation model 12c, and guidance processing information 12d.

The VR content DB 12a is a database including a group of VR contents which can be provided to the HMD 3. The user information 112b is information on users who use the HMD 3, and includes the above-mentioned various parameters of each user representing the sickness likelihood and so on. The user information 12b is updated appropriately on the basis of the past VR sickness status estimation result of the user U.

The estimation model 12c is an estimation model generated using the above-mentioned machine learning algorithm. For example, if receiving data representing various internal and external conditions of the user U and acquired by an acquiring unit 13b to be described below, the estimation model 12c calculates a value representing the VR sickness status of the user U (for example, a level value representing the degree of VR sickness), and outputs it.

The guidance processing information 12d is information on guidance processing to be performed depending on the degree of VR sickness of the user U, and includes, for example, thresholds for the degree of VR sickness at which the guidance processing should be performed, etc.

The control unit 13 is a controller, and is implemented, for example, by executing various programs (not shown in the drawings) stored in the storage unit 12 using a RAM as a work area by a central processing unit (CPU), a micro processing unit (MPU), or the like. Also, the control unit 13 may be implemented with integrated circuits such as an application specific integrated circuit (ASIC), a field programmable gate array (FPGA), and so on.

The control unit 13 includes a providing unit 13a, the acquiring unit 13b, an estimating unit 13c, and the guidance processing unit 13d, and implements or executes the functions and actions of information processing to be described below.

The providing unit 13a provides a VR content stored in the VR content DB 12a to the HMD 3. Also, the providing unit 13a acquires changes in the conditions detected by the sensor unit 3c of the HMD 3 as needed, and reflects the changes in the conditions to the VR content.

The acquiring unit 13b acquires sensing data from the various sensors 7 as needed. Also, the acquiring unit 13b acquires VR content use states, such as the type of the VR content which is being provided, the video state, and the sound state, from the providing unit 13a, as needed. Also, the acquiring unit 13b outputs the variety of acquired data to the estimating unit 13c.

The estimating unit 13c estimates the VR sickness status of the user U using the estimation model 12c, on the basis of the variety of data acquired by the acquiring unit 13b. Also, the estimating unit 13c outputs the estimation result to the guidance processing unit 13d.

The guidance processing unit 13d performs a guidance processing such that the driving state of the vehicle V is guided to suppress VR sickness, depending on the estimation result of the estimating unit 13c. However, the acquiring unit 13b, the estimating unit 13c, and the guidance processing unit 13d may perform processing assigned to them when a VR content is being provided to the HMD 3 by the providing unit 13a.

Therefore, in this case, the providing unit 13a switches on the acquiring unit 13b, the estimating unit 13c, and the guidance processing unit 13d when providing a VR content to the HMD 3. Further, the providing unit 13a switches off the acquiring unit 13b, the estimating unit 13c, and the guidance processing unit 13d when it does not provide any VR content to the HMD 3. Hysteresis control and slowdown control may be performed in switching.

By the way, it is desirable to provide a switch capable of switching on this device even when any VR content is not being used such that the user can use the device to reduce general carsickness when the user wants to. In this case, it is desirable to perform reinforcement learning of sickness estimation and adaptive control when any VR content is not used.

As shown in FIG. 5, the guidance processing unit 13d includes an operation instruction unit 13da, a driving-performance changing unit 13db, and a driving-route changing unit 13dc. The guidance processing unit 13d performs a guidance processing.

As described already, an example of the guidance process is an “operation instruction process” to instruct the driver of the vehicle V in the driving operation method. Another example of the guidance processing is a “driving-performance changing processing” to change the setting related to the driving performance of the vehicle V. A further example of the guidance processing is a “driving-route changing process” to change the driving route of the vehicle V.

The operation instruction unit 13da performs the “operation instruction processing”. Further, the driving-performance changing unit 13db performs the “driving-performance changing processing”. Furthermore, the driving-route changing unit 13dc performs the driving-route changing processing.

Each of these guidance processing may be performed, for example, when the level value representing the degree of VR sickness of the user U estimated by the estimating unit 13c exceeds a predetermined threshold. FIG. 6 is a view illustrating examples of thresholds at each of which the guidance processing is triggered. As shown in FIG. 6, the thresholds are set, for example, depending on the types of contents.

As shown in FIG. 6, the sickness likelihood of each content is calculated using a calculation formula, table data, and so on, for example, by a sickness-likelihood calculating processing performed by the estimating unit 13c. Sickness likelihoods can be calculated and estimated depending on the types of contents including genres such as the action genre and the horror genre. By content makers and so on, indexes representing sickness likelihoods may be added to the contents, for example, as metadata. Also, in advance, a server device may collect data representing the degrees of sickness of users U during actual reproduction of contents, and analyze the data, and make a database of the sickness likelihoods of the individual contents.

On the basis of the calculated value representing the sickness likelihood, the estimating unit 13c calculates individual control execution thresholds. This calculation may be executed using calculation formulae corresponding to the graphs shown in FIG. 6. The calculation may be executed by using table data representing the relation between thresholds and sickness likelihoods mapped in advance.

By the way, three table data items (also referred to as threshold graphs) are prepared, for example, in the order of driving-performance changing, operation instruction, and driving-route changing from one having the least influence on the movement (trip) of the vehicle V, as shown in FIG. 6.

Further, when the VR sickness status reaches a threshold, the guidance processing unit 13d performs the driving-performance changing processing, the operation instruction processing, or the driving-route changing processing corresponding to the corresponding threshold. For example, it is assumed that the sickness likelihood of Content A is “a” and thresholds at that sickness likelihood are “ya1”, “ya2”, and “ya3” as shown in FIG. 6.

In this case, when a person called Mr. m as a user U is using Content A and the VR sickness degree Ym of Mr. m increases, and when it reaches the threshold “ya1”, the estimating unit 13c causes the guidance processing unit 13d to perform the driving-performance changing processing. In other words, the guidance processing unit 13d switches the driving performance of the vehicle V to a mode in which sickness likelihood is low. Also, when the VR sickness degree Ym increases, and when it reaches the threshold ya2, the estimating unit 13c causes the guidance processing unit 13d to perform the operation instruction processing. In other words, the guidance processing unit 13d switches the operation instruction of the vehicle V to a mode in which sickness likelihood is low. Also, when the VR sickness degree Ym increases, and when it reaches the threshold ya3, the estimating unit 13c causes the guidance processing unit 13d to perform the driving-route changing processing. In other words, the guidance processing unit 13d switches the driving route of the vehicle V to a mode in which sickness likelihood is low (i.e. it changes the driving route).

Further, there is a control method of resetting the mode when the VR sickness degree decreases. In this control, a threshold for resetting is a threshold with hysteresis (i.e. a value representing a VR sickness degree lower than those of the thresholds ya1, ya2, and ya3). However, a control method which does not reset the mode even though the VR sickness degree decreases may be adopted.

Each threshold is deselected when reproduction of the content ends, and when another content is selected, another threshold is set. Alternatively, each threshold may be deselected after the trip of the vehicle V finishes.

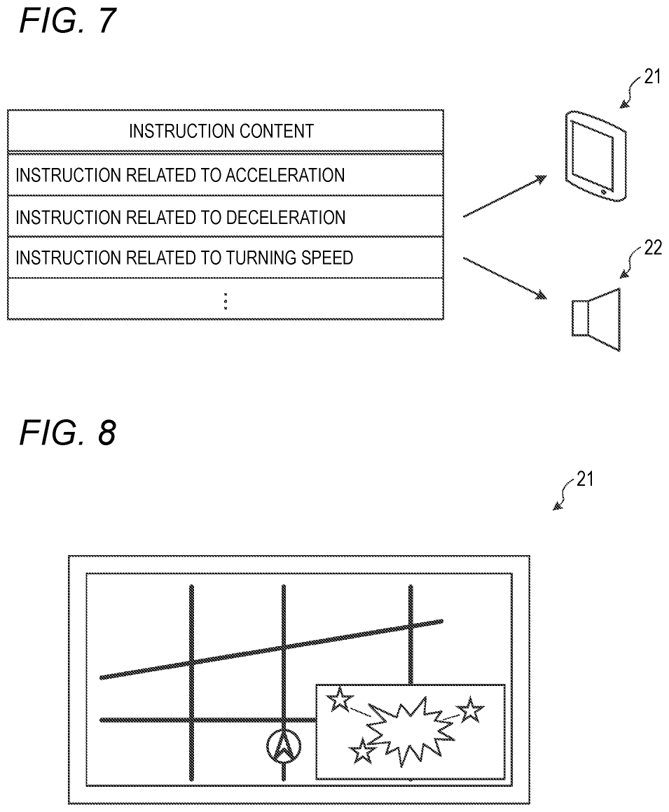

The operation instruction processing which the operation instruction unit 13da performs will be described. FIG. 7 is a view illustrating instruction contents in the operation instruction processing. FIG. 8 is a view illustrating an output example of the operation instruction processing.

As shown in FIG. 7, the operation instruction unit 13da generates, for example, an instruction related to acceleration (such as “Speed up slowly at half the usual acceleration”), an instruction related to deceleration (such as “Speed down slowly at twice the usual deceleration distance”), or an instruction related to turning speed (such as “Turn slowly at half the usual speed”), on the basis of the variety of data acquired by the acquiring unit 13b and the estimation result of the estimating unit 13c. The display 21 may be an instrument panel, a head-up display, etc., other than the display of the car navigation system.

Also, the operation instruction unit 13da may display the video of the VR content which is being provided to the user U, on the display 21. In the example of FIG. 8, an example in which the video of a VR content is displayed on a part of the car navigation screen is shown. As a result, the driver can grasp the contents of the VR content which is being provided to the user U, and, for example, if the VR content is considered a content likely to cause sickness, the driver can get ready to perform slow acceleration or deceleration.

Instead of the video of the VR content, images deformed such that it is possible to see sickness likelihoods from them, for example, a video of impression images obtained by applying various filters to the video of the VR content, or an image in which the sickness likelihood and features (such as quick motion or change) of the content are expressed by display colors, letters, characters, and the like may be displayed.

Also, while the video of a VR content is displayed, the sound of the VR content or deformed sound may be output from the speaker 22.

Now, the driving-performance changing processing which the driving-performance changing unit 13db performs will be described. FIG. 9 is a view illustrating examples of parameters which can be changed by the driving-performance changing processing. As shown in FIG. 9, the driving-performance changing unit 13db changes, for example, the settings of parameters related to the control sensitivity of the driving system and the characteristics of the vehicle mechanism system. As for parameters related to the control sensitivity of the driving system, the driving-performance changing unit changes, for example, an operation speed coefficient or the like. In other words, for example, in order to moderate the acceleration at the time of starting, fuel injection control, motor control, and the like is changed such that even through the driver performs a usual operation on the accelerator, the torque or rotation speed of the engine does not rapidly become high. As for parameters related to the characteristics of the vehicle mechanism system, the driving-performance changing unit changes, for example, the suspension hardness, the damper braking characteristic, and the like.

Then, the driving-performance changing unit 13db outputs the changed parameters to the vehicle control device 30, and causes the vehicle control device 30 to perform vehicle control according to the changed parameters.

It may be displayed or given a notification to the driver that the driving performance has been changed, together with the reason that some degree of sickness has occurred, for example.

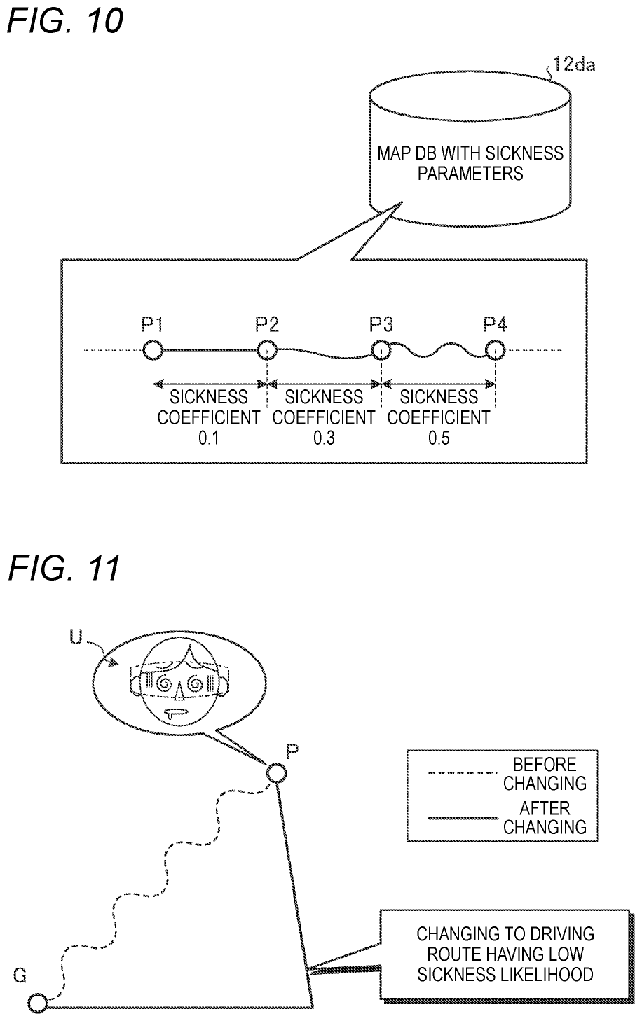

Now, the driving-route changing processing which the driving-route changing unit 13dc performs will be described. FIG. 10 is a view for explaining the driving-route changing processing. FIG. 11 is another view for explaining the driving-route changing processing. As shown in FIG. 10, the driving-route changing unit 13dc changes the driving route, for example, on the basis of map data included in a map DB 12da with sickness parameters. The map DB 12da with sickness parameters is included, for example, in the guidance processing information 12d. The map DB 12da with sickness parameters is, for example, a database of map data including sickness coefficients set for individual road sections to be assigned as weights to sickness likelihoods.

By the way, as the map DB 12da with sickness parameters, a map storage device may be implemented with a storage device (a storage medium) such as a non-volatile memory, a hard disk, an optical disk, or the like, and be provided. For example, the map DB with sickness may be stored in the information processing device 10, or may be provided from a server device connected to the information processing device 10 by radio. Further, the map DB 12da with sickness parameters may be appropriately learned and reinforced in the information processing device 10 or the server device on the basis of data acquired in real time in the information processing device 10 or data collected from individual information processing devices 10.

FIG. 10 schematically shows map data set such that sickness coefficients gradually increase over a section between P1 and P2, a section between P2 and P3, and a section between P3 and P4 as the numbers of curves in the sections gradually increase. By the way, the sickness likelihood index of each route may be calculated by a method of calculating the product of the distance of each of the sections of the target route and the sickness coefficient of the corresponding section and summing up the calculation results, or the like. Also, in order to avoid sudden sickness, sections where sickness likelihoods are high may be avoided. So an upper limit for sickness likelihoods may be set and a detour route, for example, except for routes including sections having sickness coefficients larger than a threshold or sections each of which has the product of the distance of the section and the sickness coefficient of the section larger than a threshold, may be selected.

As shown in FIG. 11, for example, if the VR sickness level value of the user U exceeds the above-mentioned threshold at a point P, the driving-route changing unit 13dc calculates another driving route to a description G on the basis of the map DB 12da with sickness parameters, and changes the route to a driving route in which the sickness likelihood is low. FIG. 11 shows an example in which a driving route having many curves is changed to a driving route calculated as a route having more straight sections and having a lower sickness likelihood although it is a devious route as compared to the original driving route. By the way, the driving-route changing unit 13dc may be configured to estimate sickness likelihoods from the numbers of curves, uphills, downhills, intersections, etc., on the basis of map data without sickness parameters. Also, the driving-route changing unit 13dc may be configured to calculate the sickness likelihoods of a plurality of driving routes when a destination G is set, and recommend a driving route having the lowest sickness likelihood.

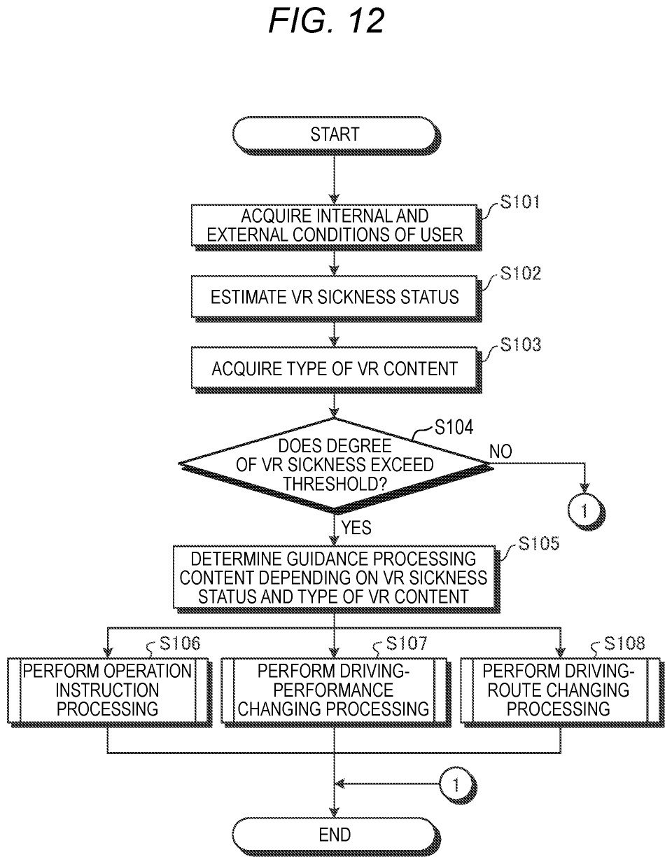

Now, procedures which the information processing device 10 according to the first embodiment performs will be described with respect to FIG. 12 to FIG. 15. FIG. 12 is a flow chart illustrating the procedures which the information processing device 10 according to the first embodiment performs. By the way, the corresponding processing may be repeatedly performed while a VR content is used, and when a selection is made to operate a sickness suppressing function, even when any VR content is not used, the corresponding processing may be repeatedly performed while the vehicle is used (travelling).

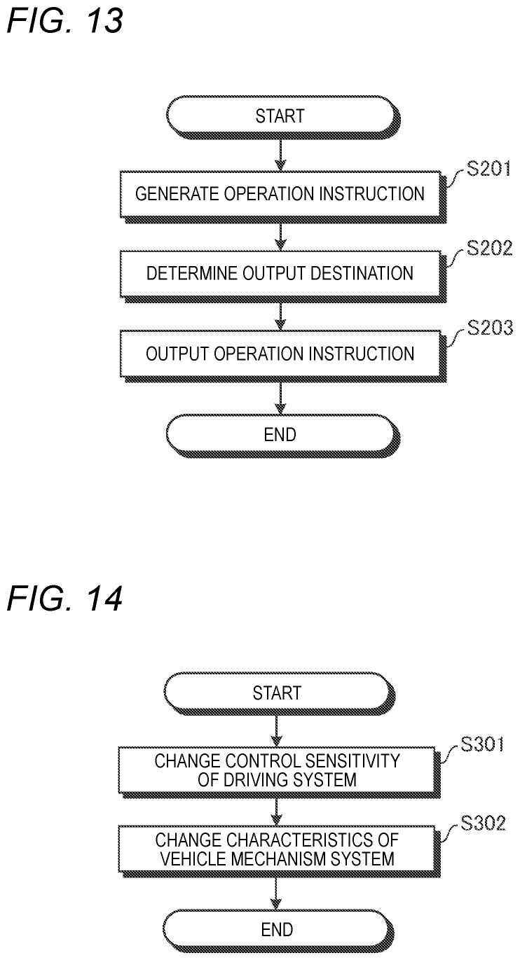

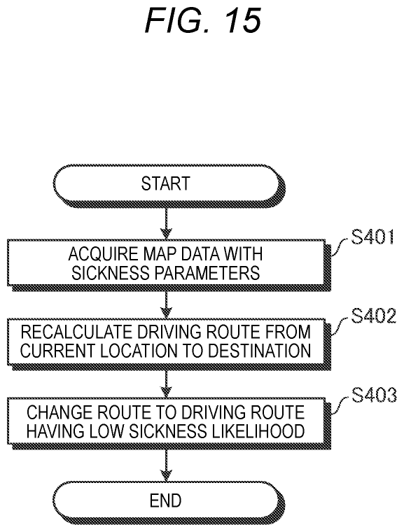

FIG. 13 is a flow chart illustrating the procedures of the operation instruction processing. FIG. 14 is a flow chart illustrating the procedures of the driving-performance changing processing. FIG. 15 is a flow chart illustrating the procedures of the driving-route changing processing. The processing procedure shown in FIG. 12 may be repeated as needed while the providing unit 13a provides a VR content to the HMD 3.

As shown in FIG. 12, first, the acquiring unit 13b acquires the internal and external conditions of the user U (STEP S101). Then, the estimating unit 13c estimates the VR sickness status of the user U on the basis of the acquired conditions (STEP S102). Also, the acquiring unit 13b acquires the type of the VR content (STEP S103).

Then, the guidance processing unit 13d determines whether the degree of VR sickness of the user U exceeds a predetermined threshold or not (STEP S104). In the case where it is determined that the degree of VR sickness exceeds the threshold (“Yes” in STEP S104), the guidance processing unit 13d determines a guidance processing content depending on the VR sickness status and the type of the VR content (STEP S105).

Then, on the basis of the determined content, the guidance processing unit 13d performs the operation instruction processing of STEP S106, the driving-performance changing processing of STEP S107, and/or the driving-route changing processing of STEP S108, and ends the processing. The processing of STEPs S106 to S108 may be performed alternatively, and of the three processing, at least two processes may be performed in parallel.

Meanwhile, in the case where it is determined in STEP S104 that the degree of VR sickness does not exceed the threshold (“No” in STEP S104), the guidance processing unit ends the processing.

In the operation instruction processing, as shown in FIG. 13, the operation instruction unit 13da generates an operation instruction related to, for example, acceleration, deceleration, or turning speed, on the basis of the variety of data acquired by the acquiring unit 13b and the estimation result of the estimating unit 13c (STEP S201).

Then, the operation instruction unit 13da determines an output destination according to the generated operation instruction (STEP S202). Subsequently, the operation instruction unit 13da outputs the operation instruction to the determined output destination (STEP S203), and ends the processing.

Though the case where the operation instruction processing gives an operation instruction to the driver of the vehicle V has been described above, in the case where the vehicle V is an autonomous driving vehicle, an operation instruction may be given to the vehicle control device 30 to execute automatic driving control. In this case, the operation instruction unit 13da generates an operation instruction signal for the vehicle control device 30, and selects the vehicle control device 30 as the output destination, and outputs the operation instruction signal to the vehicle control device 30. Further, in this case, the content of the operation instruction for automatic driving control is displayed (notified) to the passengers such as the driver, such that the passengers recognize it.

In the driving-performance changing processing, as shown in FIG. 14, the driving-performance changing unit 13db changes, for example, the control sensitivity of the driving system (STEP S301). Also, the driving-performance changing unit 13db changes, for example, the characteristics of the vehicle mechanism system (STEP S302). Then, driving-performance changing unit ends the processing. Further, in this case, the content of the driving performance change is displayed (notified) to the passengers such as the driver such that the passengers recognize it.

In the driving-route changing processing, as shown in FIG. 15, the driving-route changing unit 13dc acquires map data with sickness parameters (STEP S401). Subsequently, on the basis of the acquired map data, the driving-route changing unit 13dc recalculates driving routes from the current location to the destination (STEP S402). Then, the driving-route changing unit 13dc changes the driving route to a driving route having a low sickness likelihood, on the basis of the recalculation result (STEP S403), and ends the processing. Further, in this case, the content of the driving route change is displayed (notified) to the passengers such as the driver such that the passengers recognize it.

Also, it may be possible for the driver to make a route change prohibition instruction by a switch operation or the like (by adding a switch operation determination processing and a route maintenance processing) such that it is possible to prevent inconvenient route changes.

As described above, the information processing device 10 according to the first embodiment is an information processing device that is mountable on the vehicle V, and includes the acquiring unit 13b, the estimating unit 13c, and the guidance processing unit 13d. The acquiring unit 13b acquires the internal and external conditions of the user U of a VR content (corresponding to an example of a “digital content including a virtual space experience”). The estimating unit 13c estimates the sickness status of the user U, on the basis of the conditions acquired by the acquiring unit 13b. The guidance processing unit 13d performs a guidance processing such that the driving state of the vehicle V is guided to suppress sickness, depending on the sickness status estimated by the estimating unit 13c.

Therefore, according to the information processing device 10 of the first embodiment, it is possible to prevent VR sickness of the user U from being caused by VR contents.

Further, the guidance processing unit 13d performs the operation instruction processing to provide an instruction related to a driving operation on the vehicle V, as the guidance processing.

Therefore, according to the information processing device 10 of the first embodiment, it is possible to perform guidance such that the driving state of the vehicle V is guided to suppress sickness, on the basis of the driving operation on the vehicle V.

Further, the vehicle V is an autonomous driving vehicle controlled by the vehicle control device 30, and the guidance processing unit 13d performs the operation instruction processing on the vehicle control device 30.

Therefore, according to the information processing device 10 of the first embodiment, even in the case where the vehicle V is an autonomous driving vehicle, it is possible to guide the driving state of the vehicle V to suppress sickness, on the basis of driving operations on the vehicle V.

Further, the guidance processing unit 13d performs the driving-performance changing processing to charge the setting related to the driving performance of the vehicle V, as the guidance processing.

Therefore, according to the information processing device 10 of the first embodiment, by changing the setting related to the driving performance of the vehicle V, it is possible to guide the driving state of the vehicle V to suppress sickness.

Further, in the driving-performance changing process, the guidance processing unit 13d changes at least one of parameters related to the control sensitivity of the driving system or parameters related to the characteristics of the vehicle mechanism system.

Therefore, according to the information processing device 10 of the first embodiment, by changing parameters related to the operation speed coefficient, the suspension hardness, the damper braking characteristic, and the like, it is possible to guide the driving state of the vehicle V to suppress sickness.

Further, the guidance processing unit 13d performs the driving-route changing processing to change the driving route of the vehicle V, as the guidance processing.

Therefore, according to the information processing device 10 of the first embodiment, by changing the driving route of the vehicle V, it is possible to guide the driving state of the vehicle V to suppress sickness.

Further, in the driving-route changing process, the guidance processing unit 13d calculates a driving route on the basis of map data in which parameters related to sickness likelihoods are set for individual road sections.

Therefore, according to the information processing device 10 of the first embodiment, it is possible to change the driving route to a driving route having a lower sickness likelihood.

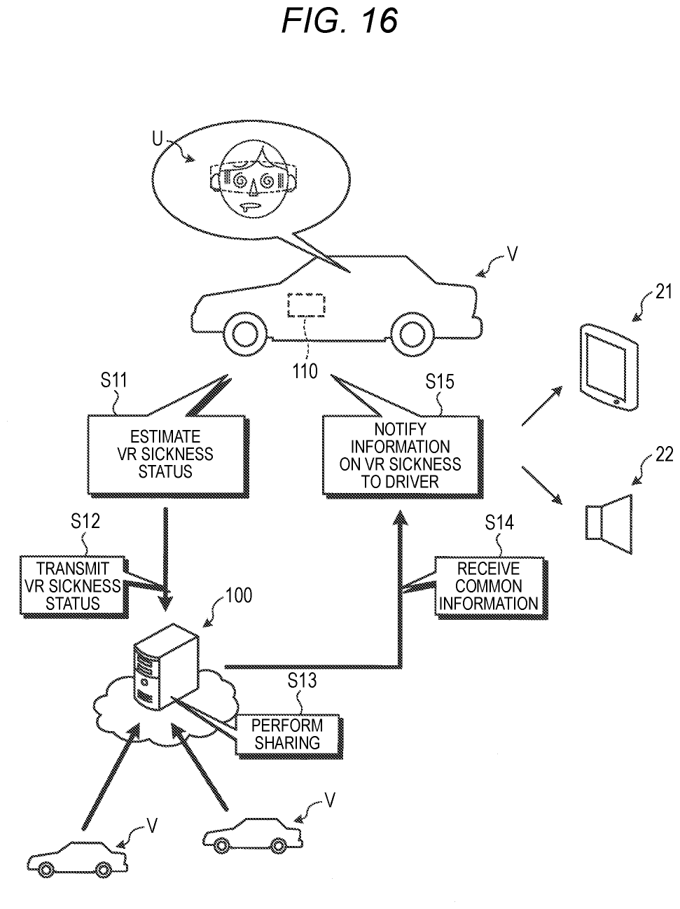

Next, the outline of an information processing method according to a second embodiment will be described with reference to FIG. 16. FIG. 16 is a view for explaining the outline of the information processing method according to the second embodiment.

The information processing method according to the second embodiment is an information processing method using an information processing device 110 which is mounted on a vehicle, and is configured to acquire the internal and external conditions of a user U, and estimate the VR sickness status of the user U on the basis of the acquired conditions, and notify the driver of information on VR sickness based on the estimated VR sickness status.

Specifically, as shown in FIG. 16, in the information processing method according to the second embodiment, the information processing device 110 acquires the internal and external conditions of the user U as needed, and estimates the VR sickness status of the user U (STEP S11). The information processing device 110 estimates the VR sickness status, for example, on the basis of a report from the user U. Also, the information processing device 110 estimates the VR sickness status, for example, by detecting changes in the physical condition of the user U.

Also, the information processing device 110 estimates the VR sickness status on the basis of VR content use states such as the type of the VR content which is being provided, the video state, and the sound state.

Also, the information processing device 110 estimates the VR sickness status on the basis of the driving states of a vehicle V such as the road condition, the condition of the vehicle V, and the operation condition. Also, the information processing device 110 estimates the VR sickness status on the basis of user information including various parameters representing, for example, the sickness likelihoods and so on of individual users.

By the way, the information processing device 110 can use an estimation model generated using, for example, a machine learning algorithm, in the VR sickness status estimating process. The estimation model is appropriately learned on the basis of actual VR sickness status estimation results by reinforcement learning. As the result of the reinforcement learning, for example, determination thresholds and so on for estimating the VR sickness status are appropriately updated.

Subsequently, the information processing device 110 transmits the VR sickness status estimated in STEP S11, to a server device 100 (STEP S12). Further, at this time, the information processing device 110 can transmit the variety of data used to estimate the VR sickness status, the model of the vehicle V, the attributes of the driver and the user U, and so on together.

The server device 100 is provided so as to be able to execute communication with the information processing device 110 through a network (not shown in the drawing) such as the Internet, a mobile phone network, and so on. The server device 100 is configured, for example, as a cloud server for providing cloud services through the network. Further, the server device 100 is generally provided so as to be able to execute communication with the information processing devices 110 of a plurality of vehicles V, and collects the VR sickness status from the individual information processing devices 110, and shares them (STEP S13). The sharing includes compiling statistics using statistical processing.

Then, the information processing device 110 receives the shared information from the server device 100 (STEP S14). Subsequently, on the basis of the shared information, the information processing device 110 notifies information on VR sickness to the driver. Examples of the notification destination include the display 21, the speaker 22, and so on mounted on the vehicle V.

The notified information on VR sickness is, for example, a score calculated on the basis of the VR sickness status of the user U. The score is, for example, a VR sickness prevention driving degree. In this way, for example, the influence of driving operations of the driver on VR sickness is visualized, whereby it is possible to urge the driver to perform driving operations to suppress occurrence of VR sickness.

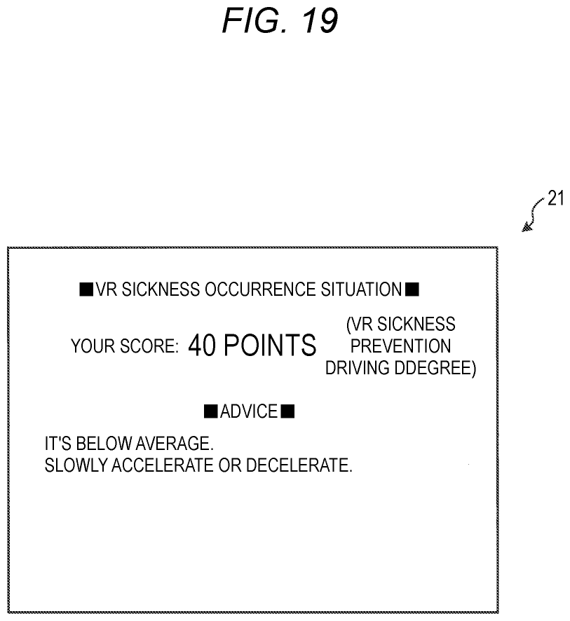

Also, the notified information on VR sickness is, for example, ranking information based on the information shared by the plurality of vehicles V. A specific notification example of information on VR sickness will be described in the following descriptions using FIG. 19 to FIG. 21.

As described above, the information processing method according to the second embodiment is an information processing method using the information processing device 110 which is mounted on the vehicle V, and is configured to acquire the internal and external conditions of the user U, and estimate the VR sickness status of the user U on the basis of the acquired conditions, and notify information on VR sickness based on the estimated VR sickness status.

Therefore, according to the information processing method of the second embodiment, it is possible to visualize, for example, the influence of driving operations of the driver on VR sickness, and urge the driver to perform driving operations to suppress occurrence of VR sickness. In other words, it is possible to prevent VR sickness of the user U from being caused by VR contents. Hereinafter, a configuration example of an information processing system 101 using the information processing method according to the second embodiment will be described in more detail.

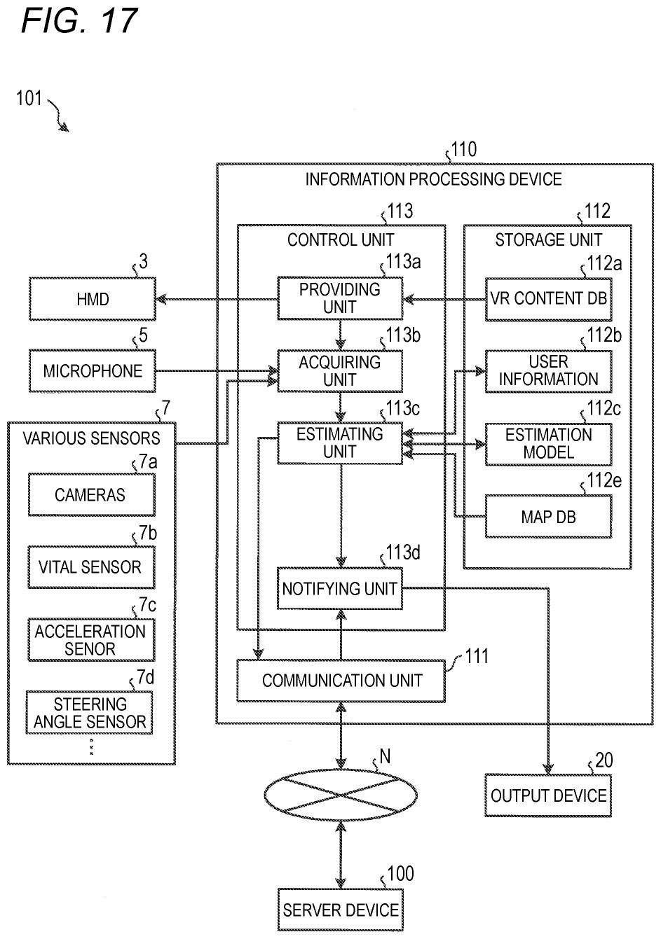

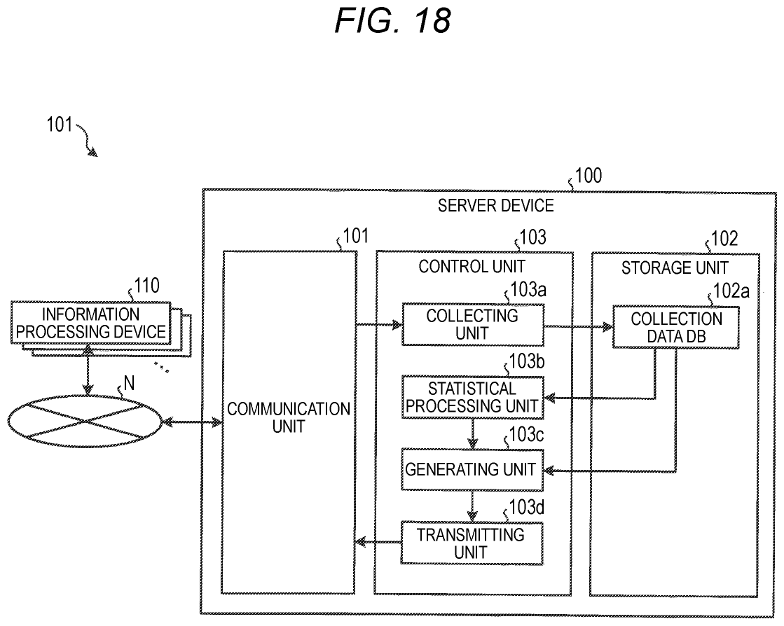

FIG. 17 is a block diagram illustrating the configuration example of the information processing system 101 according to the second embodiment. Also, FIG. 18 is another block diagram illustrating the configuration example of the information processing system 101 according to the second embodiment. In FIG. 17 and FIG. 18, only components necessary to explain the features of the second embodiment are shown, and general components are not shown.

In other words, the individual components shown in FIG. 17 and FIG. 18 are functionally conceptual, and do not necessarily need to be configured physically as shown in the drawings. For example, specific forms of distribution and combination of the individual blocks are not limited to that shown in the drawings, and all or some of them may be functionally and physically distributed or combined in desired units, depending on various types of loads, use states, etc.

Further, in descriptions using FIG. 17 and FIG. 18, a description of the components having been already described will be made in brief or will not be made here.

As shown in FIG. 17, the information processing system 101 according to the second embodiment includes an HMD 3, an information processing device 110, and a server device 100.

The HMD 3 is identical to the HMD 3 described in association with the first embodiment with reference to FIG. 1, so a description thereof will not be made. The information processing device 110 includes a communication unit 111, a storage unit 112, and a control unit 113. Also, the information processing device 110 is connected to a microphone 5, various sensors 7, and an output device 20 directly or through a network such as a controller area network (CAN).

The microphone 5 is a sound collecting device which is mounted inside the vehicle V. The various sensors 7 and the output device 20 are identical to the various sensors 7 and the output device 20 described in association with the first embodiment with reference to FIG. 4, so a description thereof will not be made here.

The communication unit 111 is implemented with, for example, a network interface card (NIC) and so on. The communication unit 111 is connected to a network N such as the Internet, mobile phone networks, etc., and transmits and receives information to and from the server device 100 through the network.

The storage unit 112 is implemented with, for example, semiconductor memory devices such as a random access memory (RAM) and a flash memory, or storage devices such as a hard disk and an optical disk, and in the example of FIG. 17, the storage unit stores a VR content database (DB) 112a, user information 112b, an estimation model 112c, and a map DB 112e.

The VR content DB 112a is a database including a group of VR contents which can be provided to the HMD 3. The user information 12b is information on users who use HMDs 3, and includes the above-mentioned various parameters of each user representing the sickness likelihood and so on. The user information 112b is updated appropriately on the basis of the past VR sickness status estimation results of the users U.

The estimation model 112c is an estimation model generated using the above-mentioned machine learning algorithm. For example, if receiving data representing various internal and external conditions of the user U acquired by an acquiring unit 113b to be described below, the estimation model 112c calculates a value representing the VR sickness status of the user U (for example, a level value representing the degree of VR sickness), and outputs it.

The map DB 112e is a database having map data. The map data may include not only map information but also, for example, information on the materials of roads, uphills, downhills, etc. In this case, it becomes possible to particularly calculate, for example, the condition of the road where the vehicle is traveling, on the occasion of VR sickness status estimation.

The control unit 113 is a controller, and is implemented, for example, by executing various programs (not shown in the drawings) stored in the storage unit 112 using a RAM as a work area by a central processing unit (CPU), a micro processing unit (MPU), or the like. Also, the control unit 113 may be implemented with integrated circuits such as an application specific integrated circuit (ASIC), a field programmable gate array (FPGA), and so on.

The control unit 113 includes a providing unit 113a, the acquiring unit 113b, an estimating unit 113c, and a notifying unit 113d, and implements or executes the functions and actions of information processing to be described below.

The providing unit 113a provides a VR content stored in the VR content DB 112a to the HMD 3. Also, the providing unit 113a acquires changes in the conditions detected by the sensor unit 3c of the HMD 3 as needed, and reflects the changes in the conditions to the VR content.

The acquiring unit 113b acquires the vocal data of the user U collected by the microphone 5 and sensing data of the various sensors 7 as needed. Also, the acquiring unit 113b acquires the use states of the VR content which is being provided, such as the type of the VR content, the video state, and the sound state, from the providing unit 113a, as needed. Also, the acquiring unit 113b outputs the variety of acquired data to the estimating unit 113c.

The estimating unit 113c estimates the VR sickness status of the user U using the estimation model 112c, on the basis of the variety of data acquired by the acquiring unit 113b. Further, the estimating unit 113c performs a voice recognition processing and a natural language processing on the vocal data of the user U, and determines, for example, whether it's a report of occurrence of VR sickness, on the basis of the processing result, and estimates the degree of VR sickness and so on if it's a report of occurrence of VR sickness.

Further, the estimating unit 113c calculates, for example, the score related to driving operations of the driver and called the VR sickness prevention driving degree, and so on, on the basis of the above-mentioned level value representing the degree of VR sickness and estimated using the estimation model 112c. Also, the estimating unit 113c transmits the estimation result, the calculated score, and so on to the server device 100 through the communication unit 111. However, the estimating unit 113c may output the estimation result, the calculated score, and so on directly to the notifying unit 113d.

The notifying unit 113d receives the information on VR sickness transmitted from the server device 100, through the communication unit 111, and notifies the driver of the received information to the output device 20.

However, the acquiring unit 113b, the estimating unit 113c, and the notifying unit 113d may be configured to perform processing assigned to them when a VR content is being provided to the HMD 3 by the providing unit 113a.

Therefore, in this case, the providing unit 113a switches on the acquiring unit 113b, the estimating unit 113c, and the notifying unit 113d when providing a VR content to the HMD 3. Also, the providing unit 113a switches off the acquiring unit 113b, the estimating unit 113c, and the notifying unit 113d when it does not provide any VR content to the HMD 3. Hysteresis control and slowdown control may be performed in the switching.

By the way, it may be desirable to provide a switch capable of switching on this device even when any VR content is not being used such that the user can use the device to reduce general carsickness when the user wants to. In this case, it may be desirable to perform reinforcement learning of sickness estimation and adaptive control when any VR content is not used.

Now, a configuration example of the server device 100 will be described. As shown in FIG. 18, the server device 100 includes a communication unit 101, a storage unit 102, and a control unit 103.

The communication unit 101 is implemented with, for example, an NIC and so on, similarly to the communication unit 111. The communication unit 101 is connected to the network N such as the Internet, mobile phone networks, and so on, by wire or radio, and transmits and receives information to and from the information processing device 110 through the network N.

The storage unit 102 is implemented with, for example, semiconductor memory devices such as a RAM and a flash memory, or storage devices such as a hard disk and an optical disk, similarly to the storage unit 112, and in the example of FIG. 18, the storage unit stores a collection data DB 102a.

In the collection data DB 102a, a variety of data including VR sickness status, collected from the individual information processing devices 110 by a collecting unit 103a to be described below are accumulated.

Similarly to the control unit 113, the control unit 103 is a controller, and is implemented, for example, by executing various programs (not shown in the drawings) stored in the storage unit 102 using a RAM as a work area by a CPU, a MPU, or the like. Also, the control unit 103 may be implemented with integrated circuits such as an ASIC, an FPGA, and so on.

The control unit 103 includes the collecting unit 103a, a statistical processing unit 103b, a generating unit 103c, and a transmitting unit 103d, and implements or executes the functions and actions of information processing to be described below.

The collecting unit 103a collects a variety of data including VR sickness status transmitted from the individual information processing devices 110, through the communication unit 101, and accumulates them in the collection data DB 102a.

The statistical processing unit 103b performs statistical processing necessary to generate the above-mentioned ranking information and so on, on the basis of the variety of data accumulated in the collection data DB 102a.

In the statistical processing, the statistical processing unit 103b calculates, for example, a reference value (like a threshold) to be a reference for a variety of data, from the average value of the large amount of data, using the characteristics of big data. As the reference value, the statistical processing unit 103b calculates, for example, a reference value, a threshold, or the like for people's sickness likelihoods by statistical processing. At this time, the statistical processing unit may perform processing on the reference value, such as converting it to the threshold of each level such as a boundary value corresponding to 20% of the statistical distribution.

The statistical processing unit 103b constantly updates such statistical processing with acquired new data. The statistical processing result can be used in a process of determining the sickness likelihood level of each passenger by comparing the past data of the corresponding passenger acquired and accumulated in the past with the above-mentioned reference value, or can be reflected to the driver evaluation, or can be used in a process of correcting the driver evaluation. Besides, similarly, the statistical processing result can be used in a correcting or normalizing process of correcting or normalizing individual data items of data such as road features (the sickness likelihoods of individual sections), for example, on the basis of big data.

Further, the statistical processing unit 103b may be configured to learn the above-mentioned estimation model 112c using the statistical processing result, and appropriately distribute the updated estimation model 112c to the information processing device 110.

The generating unit 103c generates information on VR sickness to be transmitted to the information processing device 110, on the basis of the statistical processing result of the statistical processing unit 103b and the variety of data accumulated in the collection data DB 102a.

The transmitting unit 103d transmits the information on VR sickness generated by the generating unit 103c, to the individual information processing devices 110, through the communication unit 101.

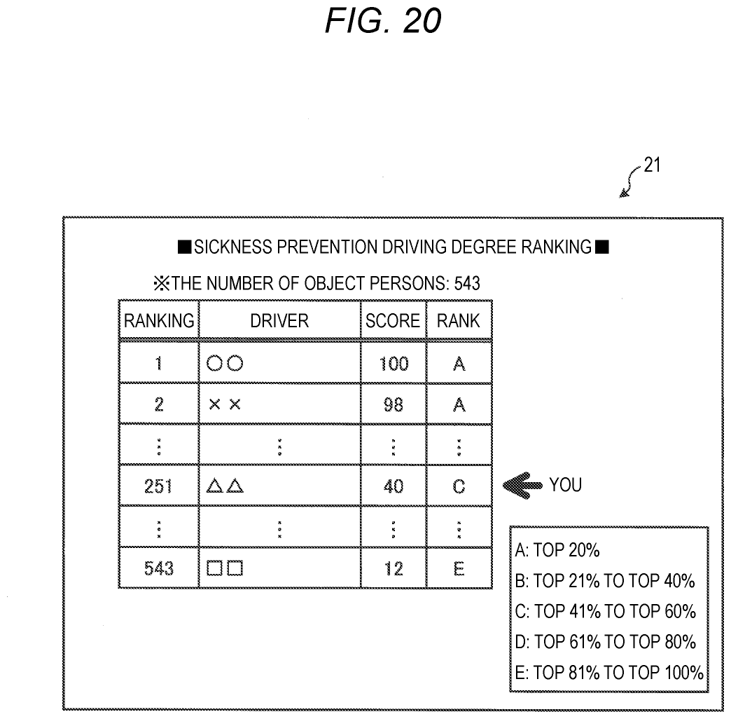

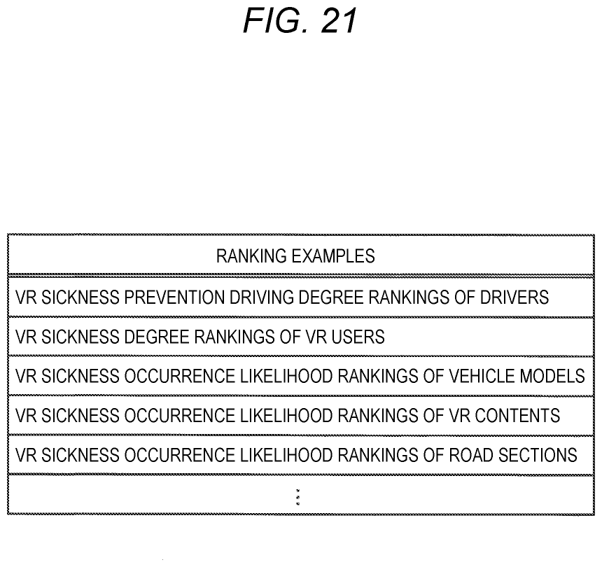

Now, a specific notification example in which the information on VR sickness is notified to the information processing device 110 will be described with reference to FIG. 19 to FIG. 21. FIG. 19 is a view illustrating an example of notification of information on VR sickness. FIG. 20 is a view illustrating an example of notification of ranking information. FIG. 21 is a view illustrating an example of ranking.

As shown in FIG. 19, for example, as a “VR sickness occurrence situation”, the score related to driving operations and called the VR sickness prevention driving degree is output to the display 21 of the information processing device 110, whereby the information on VR sickness is notified.

FIG. 19 shows an example in which the score is 40 points. Also, FIG. 19 shows the example in which an advice “IT'S BELOW AVERAGE. SLOWLY ACCELERATE OR DECELERATE.” is notified together according to the score.

In the example shown in FIG. 19, the notifying unit 113d of the information processing device 110 may be configured to output the information on VR sickness on the basis of the estimation result received directly from the estimating unit 113c, the score, and so on, not through the server device 100.

Also, as shown in FIG. 20, as the ranking information, for example, the above-mentioned score ranking is output to the display 21, thereby being notified. In this case, the ranking information is notified such that the ranking of the driver of the vehicle V is clearly expressed as shown in FIG. 20. Also, as shown in FIG. 20, the rankings in the total number of object persons, range display representing which percentage range from the top each ranking falls within (the “RANK” item of FIG. 20), and so on may be notified together.

By the notification example as shown in FIG. 19 and FIG. 20, it is possible to visualize the influence of driving operations of the driver on VR sickness, and it is possible to urge the driver to perform driving operations to suppress occurrence of VR sickness.

While the example in which the notification contents are output to the display 21 is shown in FIG. 19 and FIG. 20, the same notification contents may be notified through the speaker 22 by sound.

Further, the examples of the rankings in the ranking information are not limited to the above-mentioned scores. As shown in FIG. 21, for example, the rankings are not limited to the VR sickness prevention driving degree rankings of drivers, and may be the VR sickness degree rankings of VR users.

Further, as shown in FIG. 21, the rankings may be the VR sickness occurrence likelihood rankings of vehicle models, of VR contents, of road sections, and so on. In this case, it is possible to make the driver recognize, for example, that the model of the vehicle V which the driver drives or the road section where the vehicle is traveling is likely to cause VR sickness, and urge the driver to perform driving operations to suppress occurrence of VR sickness.

Further, the above-mentioned vehicle model includes, for example, autonomous driving vehicles. Therefore, in the case where the driver is the driver of an autonomous driving vehicle, if the model of the corresponding vehicle is likely to cause VR sickness during automatic traveling in a certain road section, it is possible to urge the driver to perform driving operations, such as switching to manual driving in the corresponding road section, to suppress occurrence of VR sickness.

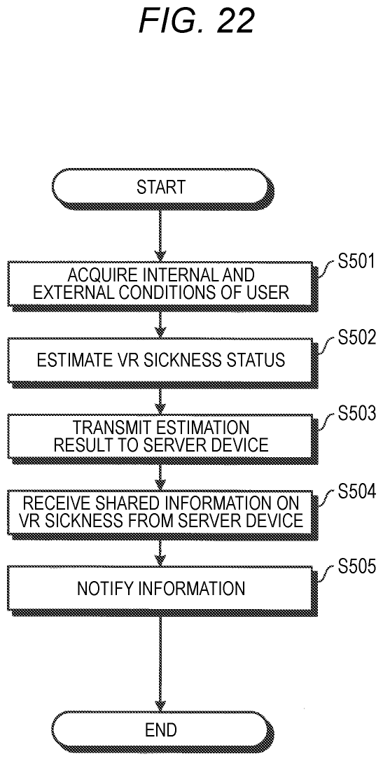

Now, the procedures of the processing performed by the information processing device 110 according to the embodiment will be described with reference to FIG. 22. FIG. 22 is a flow chart illustrating the procedures of the processing performed by the information processing device 110 according to the second embodiment. The procedures shown in FIG. 22 may be repeated as needed while the providing unit 113a provides a VR content to the HMD 3.

As shown in FIG. 22, first, the acquiring unit 113b acquires the internal and external conditions of the user U (STEP S501). Then, the estimating unit 113c estimates the VR sickness status of the user U on the basis of the acquired conditions (STEP S502).

Subsequently, the estimating unit 113c transmits the estimation result to the server device 100 (STEP S503). Then, the notifying unit 113d receives information on VR sickness shared in the server device 100, from the server device 100 (STEP S504).

Subsequently, the notifying unit 113d notifies the received information on VR sickness to the driver (STEP S505), and ends the processing.

As described above, the information processing device 110 according to the second embodiment is an information processing device that is mountable on the vehicle V, and includes the estimating unit 113c and the notifying unit 113d. The estimating unit 113c estimates the sickness status of the user U of a VR content (corresponding to an example of a “digital content including a virtual space experience”). The notifying unit 113d notifies the driver of information on sickness based on the sickness status of the user U estimated by the estimating unit 113c.

Therefore, according to the information processing device 110 of the second embodiment, it is possible to clarify the influence of driving operations of the driver on VR sickness, and urge the driver to perform driving operations to suppress occurrence of VR sickness. In other words, it is possible to prevent VR sickness of the user U from being caused by VR contents.

Also, the notifying unit 113d notifies the driver of the driving operation state of the driver related to occurrence of sickness, as the information on sickness.

Therefore, according to the information processing device 110, it is possible to, for example, visualize the driving operation state related to occurrence of sickness for the driver.

Also, the notifying unit 113d notifies the driver of the score related to driving operations, as the driving operation state, the score being calculated based on the sickness status of the user U.

Therefore, according to the information processing device 110, it is possible to clearly express the influence of driving operations of the driver on VR sickness to the driver, and it is possible to urge the driver to perform driving operations to suppress occurrence of VR sickness.

Also, the notifying unit 113d notifies the driver of an advice related to driving operations according to the score.

Therefore, according to the information processing device 110, it is possible to urge the driver to perform driving operations according to the advice.

Further, the notifying unit 113d notifies the driver of ranking information as the driving operation state, the ranking information being based on the driving operation state of the driver related to occurrence of sickness that is shared with other vehicles V.

Therefore, according to the information processing device 110, it is possible to urge the driver to perform driving operations to suppress occurrence of VR sickness in comparison with other vehicles V.

In the above-described embodiments, the configurations in which the HMD 3 and the information processing device 10 or 110 are separated from each other have been taken as examples; however, the present invention is not limited thereto. The HMD 3 and the information processing device 10 or 110 may be integrated.

Further, in the above-described embodiments, the configurations in which the information processing device 10 or 110 is separated from the output device 20 and the vehicle control device 30 have been taken as examples; however, the present invention is not limited thereto. The information processing device 10 or 110 and the output device 20, or the information processing device 10 and the vehicle control device 30, or the information processing device 10 and the output device 20 and the vehicle control device 30 may be integrated.

Further, in the above-described embodiments, the HMD 3 has been taken as an example of a presentation device for presenting VR contents provided by the information processing device 10 or 110 to the user U; however, the presentation device is not limited thereto. For example, the presentation device may be a device including a bone conduction speaker, or may be a device including a vibration presentation device for presenting vibration like bodysonic devices.

Further, the presentation device is not limited to a wearable computer, and for example, the front window, a side window, or the like of the vehicle V may be configured as a display, and videos may be output to the corresponding display. Also, sound may be output to in-vehicle speakers. In general, a plurality of in-vehicle speakers can be appropriately disposed in multiple directions including the front, the rear, the left, and the right, so it is suitable for 3D reproduction.

Further, in the above-described embodiments, the examples in which the information processing device 10 or 110 provides VR contents has been taken; however, contents provided by the information processing device need only to be digital contents including virtual space experiences, and may be augmented reality (AR) contents or MR contents.

Further, in the above-described embodiment, the sickness status of the user U is shared through the server device 100; however, it may be shared by inter-vehicle communication, road-to-vehicle communication, and so on, not through the server device 100. Also, in this case, each information processing device 110 may perform statistical processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing device that is mountable on a vehicle, comprising:
an acquiring unit configured to acquire at least one of internal condition or external condition of a user of a digital content including a virtual space experience;
an estimating unit configured to estimate a sickness status of the user based on the at least one of internal condition or external condition acquired by the acquiring unit; and
a guidance processing unit configured to perform a guidance processing such that a driving state of the vehicle is guided to suppress sickness, depending on the sickness status of the user estimated by the estimating unit.

2. The information processing device according to claim 1, wherein
the guidance processing unit performs an operation instruction processing to provide an instruction related to a driving operation on the vehicle, as the guidance processing.

3. The information processing device according to claim 2, wherein
the vehicle is an autonomous driving vehicle controlled by a vehicle control device, and
the guidance processing unit performs the operation instruction processing on the vehicle control device.

4. The information processing device according to claim 1, wherein
the guidance processing unit performs a driving-performance changing processing to change a setting related to a driving performance of the vehicle, as the guidance processing.

5. The information processing device according to claim 4, wherein,
in the driving-performance changing processing, the guidance processing unit changes at least one of parameters related to a control sensitivity of a driving system or parameters related to characteristics of a vehicle mechanism system.

6. The information processing device according to claim 1, wherein
the guidance processing unit performs a driving-route changing processing to change a driving route of the vehicle, as the guidance processing.

7. The information processing device according to claim 6, wherein,
in the driving-route changing processing, the guidance processing unit calculates the driving route based on map data in which parameters related to a sickness likelihood are set for individual road sections.

8. A map storage device storing map data in which parameters related to a sickness likelihood are set for individual road sections.

9. An information processing device that is mountable on a vehicle, comprising:
an estimating unit configured to estimate a sickness status of a user of a digital content including a virtual space experience; and
a notifying unit configured to notify a driver of the vehicle of information on sickness based on the sickness status of the user estimated by the estimating unit.

10. The information processing device according to claim 9, wherein
the notifying unit notifies the driver of a driving operation state of the driver related to occurrence of sickness, as the information on sickness.

11. The information processing device according to claim 10, wherein
the notifying unit notifies the driver of a score related to a driving operation, as the driving operation state, the score being calculated based on the sickness status of the user.

12. The information processing device according to claim 11, wherein
the notifying unit notifies the driver of an advice related to the driving operation according to the score.

13. The information processing device according to claim 10, wherein
the notifying unit notifies the driver of ranking information as the driving operation state, the ranking information being based on a driving operation state of a driver related to occurrence of sickness that is shared with another vehicle.
